(19) United States
(12) Patent Application Publication
(10) Pub. No.: US 2025/0135623 A1
(43) Pub. Date: May 1, 2025

(54) Method for Operating an Electric Tool

(71) Applicant: Robert Bosch GmbH, Stuttgart (DE)

(72) Inventors: Heiko Roehm, Stuttgart (DE); Tobias Herr, Grafenau (DE); Jens Blum, Filderstadt (DE); Marcus Schuller, Dettenhausen (DE); Florian Hoelscher, Stuttgart (DE)

(21) Appl. No.: 18/837,421

(22) PCT Filed: Dec. 27, 2022
(86) PCT No.: PCT/EP2022/087914

§ 371 Date: Aug. 9, 2024

(30) Foreign Application Priority Data
Feb. 10, 2022 (DE) 10 2022 201 366.2

(51) Int. Cl. B25F 5/00; G06F 3/04842

(52) U.S. Cl. CPC B25F 5/00; G06F 3/04842

(57) ABSTRACT

A method for operating an electric tool includes the following steps: At least one device setting of the electric tool is adjusted by actuating at least one tool-external switching option or a tool-internal switching option. The at least one device setting includes at least one operating mode and/or at least one operating parameter of the electric tool. The electric tool is locked with respect to a modification of the at least one adjusted device setting by actuating a tool-internal or tool-external switching function, wherein the electric tool is locked until one of the switching functions is actuated.

The present invention relates to a method for operating an electric tool, an electric tool for carrying out the method and a control device for carrying out the method.

Electric tools that have an interface for interaction between a user and the electric tool (Human Machine Interface, HMI) are known from the prior art. Such a user interface enables, for example, the setting of different operating modes. Particularly in the field of screwdrivers and rotary impact wrenches, it is becoming increasingly important to carry out the same work with the same tool settings, i.e. to set an electric tool specifically for a particular application.

However, preset settings can be changed knowingly or accidentally. Intentional adjustment can occur, for example, if different users are using an electric tool. However, this may be undesirable, for example, by a foreman who has made the default settings. The invention is intended to prevent or at least reduce this problem.

One task of the present invention is to provide an improved method for operating an electric tool, to provide an improved electric tool and to provide an improved control device. This task is solved by a method for operating an electric tool, an electric tool for carrying out the method and a control device for carrying out the method with the features of the respective independent claims. Advantageous further embodiments are given in dependent claims.

A method of operating an electric tool comprises the following method steps. At least one device setting of the electric tool is adjusted by actuating at least one tool-internal or tool-external switching option. The at least one device setting comprises at least one operating mode and/or at least one operating parameter of the electric tool. The electric tool is locked with regard to a modification of the at least one adapted device setting by actuating a tool-internal or tool-external switching function, wherein the electric tool is locked until one of the switching functions is actuated. Advantageously, the method makes it possible to ensure that the at least one customized device setting is not inadvertently modified.

In one embodiment, the electric tool has a user interface. The user interface has a first switching option for adjusting the at least one device setting and a first switching function for locking the electric tool. The at least one device setting is adjusted and/or the electric tool is locked via the user interface by actuating the first switching option or by actuating the first switching function. Advantageously, the electric tool can be locked directly via the user interface after the at least one device setting has been adjusted via the user interface.

In one embodiment, the electric tool is connected to a terminal device. The terminal device has a user interface with a second switching option for adjusting the at least one device setting and a second switching function for locking the electric tool. The at least one device setting is adjusted and/or the electric tool is locked via the terminal device by actuating the second switching option or the second switching function. Advantageously, this means that at least one device setting can be adjusted externally to the tool and the electric tool can be locked externally. This can be done, for example, by a foreman who wants to avoid accidentally modifying the appliance settings of the electrical appliance.

In one embodiment, the at least one device setting is adjusted via the user interface and the electric tool is locked via the terminal device, or the at least one device setting is adjusted via the terminal device and the electric tool is locked via the user interface. Advantageously, the electric tool can be set and locked both via the user interface of the electric tool and via the user interface of the terminal device.

In one embodiment, locking the electric tool via the terminal device comprises locking the at least one device setting by actuating the second switching function or locking the user interface by actuating a further second switching function.

In one embodiment, at least one further device setting is adjusted. The at least one further device setting comprises at least one further operating mode and/or at least one further operating parameter of the electric tool. The device settings are adjusted via the user interface and the other device settings are adjusted via the terminal device. Advantageously, the electric tool can be set both via the user interface of the electric tool and via the user interface of the terminal device.

In one embodiment, the electric tool is connected to another terminal device. The further terminal device has a further user interface with third switching options for adjusting the at least one device setting and a third switching function for locking the electric tool. At least one customized device setting is retained or modified via the other terminal device. Advantageously, this allows a plurality of users to access the electric tool without being restricted to one terminal device.

In one embodiment, a password required to unlock the electric tool via the terminal device is activated by activating an additional second switching function of the user interface of the terminal device. Advantageously, the electric tool is therefore particularly well protected against accidental adjustment of the tool settings. In addition, deliberate adjustment of the device settings can be avoided.

In one embodiment, the electric tool remains locked if the electric tool is disconnected from a power supply source for less than a predeterminable period of time. This has the advantage that the device settings are retained and can continue to be used if, for example, a battery pack needs to be replaced.

In one embodiment, the electric tool is reset to factory settings if the electric tool is disconnected from a power supply source for longer than a predeterminable period of time.

An electric tool comprises a control device. The control device is designed to carry out the method according to one of the embodiments mentioned. The control device is configured to be connectable to a user interface of the electric tool and to a terminal device. At least one device setting of the electric tool can be adjusted via a switching option of the user interface or a switching option of the terminal device. The electric tool can be locked with regard to a modification of the at least one adjusted device setting via a switching function of the user interface or the terminal device until one of the switching functions is actuated. In one embodiment, the electric tool is designed as an impact wrench or a rotary impact wrench.

A control device for an electric tool is designed to carry out the method according to one of the embodiments mentioned. The control device is configured to be connectable to a user interface of an electric tool and to a terminal device. The control device is designed to receive signals transmitted to the control device from the user interface or from the terminal device with commands relating to at least one device setting and commands relating to locking the electric tool and to execute the commands. The electric tool or the control device ensure that the electric tool settings are not adjusted accidentally or intentionally.

In the following, the method for operating an electric tool is explained in more detail in connection with schematic drawings. Shown are:

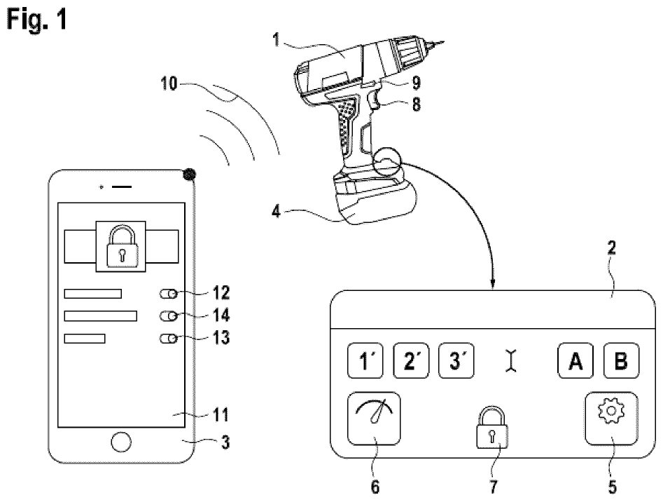

FIG. 1: an electric tool, a user interface of the electric tool and a terminal device that can be connected to the electric tool;

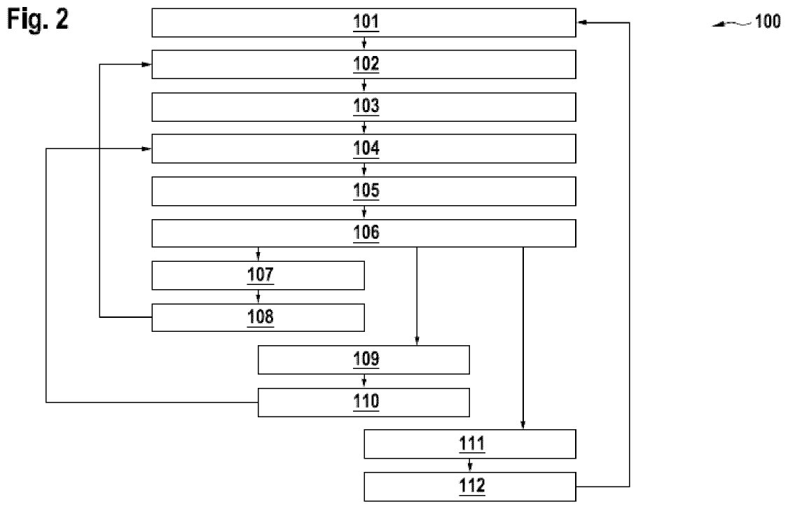

FIG. 2: Method steps of a first method for operating an electric tool;

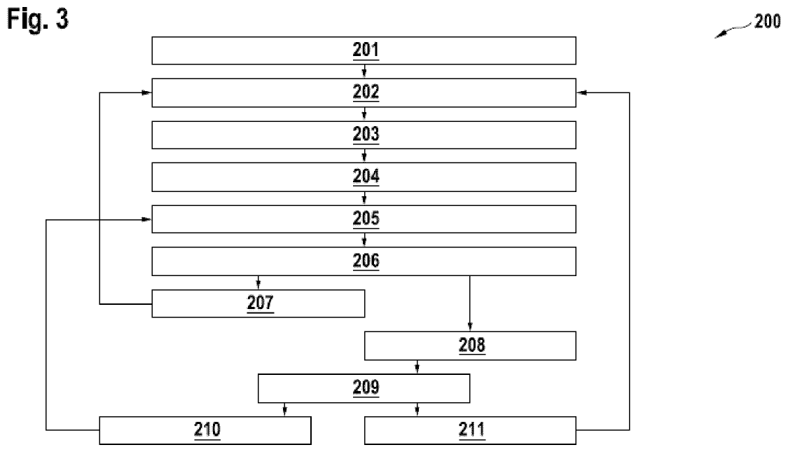

FIG. 3: Method steps of a second method for operating the electric tool;

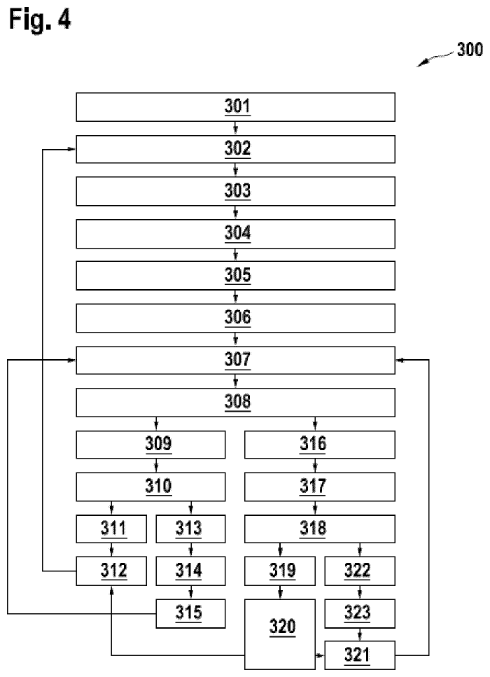

FIG. 4: Method steps of a third method for operating the electric tool; and

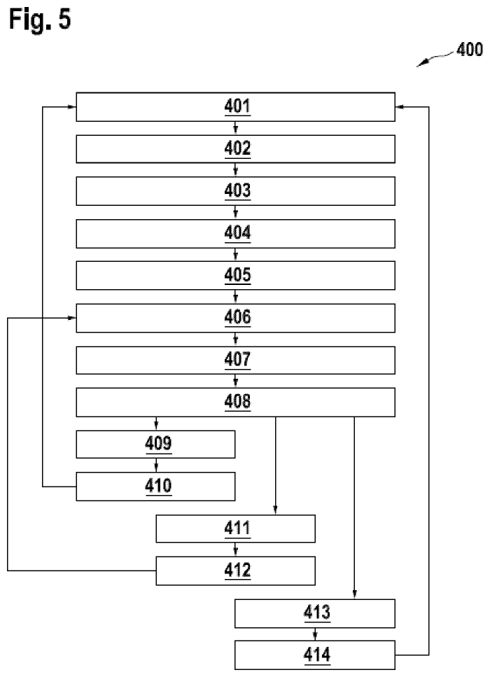

FIG. 5 Method steps of a fourth method for operating the electric tool.

FIG. 1 schematically shows an electric tool 1, a user interface 2 of the electric tool 1 and a terminal device 3. The electric tool 1 is designed as an impact wrench or rotary impact wrench, for example. However, it can also be any other electric tool 1 with a user interface 2.

The user interface 2 is arranged, for example, in an area above a power supply source 4 intended for operating the electric tool 1. The energy supply source 4 is designed as a battery pack or rechargeable battery pack, for example. However, the electric tool 1 can also be connected to a power supply network in order to be operated.

At least one device setting of the electric tool 1 can be adjusted via the user interface 2. The at least one device setting comprises at least one operating mode and/or at least one operating parameter of the electric tool 1. Adjusting a device setting comprises, for example, changing a device setting. However, customization can also consist of retaining a device setting. For example, a factory setting can be retained. In the context of the entire description, adjusting the at least one device setting thus means changing and/or maintaining the at least one device setting or device settings. For example, the electric tool 1 comprises two operating modes A, B, but it can also have only one or more than two operating modes A, Ab. The operating modes A, B can be adjusted or selected with a first switching option 5. The operating modes A, B, for example, can be modes that are intended for specific materials. For example, a first operating mode A can be provided for screw connections in metals and a second operating mode B for screw connections in wood.

The at least one operating parameter may, for example, be the speed of an electric motor of the electric tool 1. For example, the electric tool 1 can be operated in three speed levels 1′, 2′, 3′. However, more or less than three speed levels 1′, 2′, 3′ can also be provided. The operating parameter can be adjusted with a further first switching option 6. The first switching option 5 and the further first switching option 6 are designed as buttons, for example. These can also be buttons on a touch panel of the user interface 2.

The user interface 2 also has a first switching function 7. The first switching function 7 is provided for locking the electric tool 1 with regard to a modification of at least one previously adjusted device setting. The switching options 5, 6 and the first switching function 7 of the user interface 2 are tool-internal switching options 5, 6 or a tool-internal switching function 7.

In the exemplary embodiment of an impact wrench or a rotary impact wrench, the electric tool 1 has a trigger 8, a rotary switch 9 and a gear switch not shown. The trigger 8 is intended to initiate operation of the electric tool 1. The direction of rotation switch 9 is intended to set the direction of rotation of the electric tool 1. The trigger 8, the rotary switch 9 and the gear switch are not part of the user interface 2.

The electric tool 1 can be connected to the terminal device 3. The terminal device 3 is designed as a cell phone, for example. The terminal device can also be designed as another mobile terminal device, for example as a pad. However, the terminal device 3 does not necessarily have to be a mobile terminal device 3. Communication between the electric tool 1 and the terminal device 3 is bidirectional. The electric tool 1 can be connected to the terminal device 3 via a Bluetooth connection 10 or another wireless connection 10, for example.

The terminal device 1 has a user interface 11. The user interface 11 is designed as a touch panel, although this is not absolutely necessary. The user interface 11 comprises a second switching function 12 for locking the electric tool 1 with respect to a modification of the at least one adjusted device setting. A further second switching function 13 of the user interface 11 is provided for locking the user interface 2 of the electric tool 1. An additional second switching function 14 of the user interface 11 is provided to activate a password for unlocking the electric tool 1 or for unlocking the user interface 2.

The user interface 11 further comprises second switching options for customizing at least one device setting. The second switching options are not shown in FIG. 1. However, the second switching options can be accessed via a menu on the user interface 11. The second switching options can also be used, for example, to adjust various speed levels 1′, 2′, 3′ and operating modes A, B of the electric tool 1. The second switching options and the second switching functions 12, 13, 14 are tool-external switching options or tool-external switching functions 12, 13, 14.

Device settings of the electric tool 1 can therefore be adjusted via the user interface 2 and/or the terminal device 3. The electric tool 1 can also be locked with regard to a modification of at least one adjusted device setting via the first switching function 7 of the user interface 2 or a switching function 12, 13 of the terminal device 3. The electric tool 1 remains locked until one of the switching functions 7, 12, 13 is actuated. The first switching function 7 of the user interface 2 can, for example, be designed as a simple button. It can also be a lock button. The first switching function 7 can also comprise several buttons that must be pressed simultaneously. It is also possible that locking the electric tool 1 requires actuation of the first switching function 7 for a defined actuation duration, for example for at least five seconds, or with a defined actuation frequency, for example three times within one second. The required actuation duration or the required actuation frequency can also be selected differently in each case.

The electric tool 1 has a control device, which is not shown in FIG. 1. The control device can be connected to the user interface 2 of the electric tool 1 and to the terminal device 3. The control device is designed to receive signals transmitted to the control device from the user interface 2 or from the terminal device 3 with commands relating to at least one device setting and commands relating to locking the electric tool 1 and to execute the commands.

FIG. 2 schematically shows a flow diagram of a first method 200 for operating an electric tool 1 according to FIG. 1.

In an initial situation 101, the electric tool 1 is not connected to the terminal device 3. By way of example, the electric tool 1 is in a factory setting with regard to its operating modes A, B and with regard to the operating parameter. For example, no operating mode A, B is selected. Speed level 3′ is also set as an operating parameter by way of example. In a first method step 102, at least one device setting is adjusted by actuating a first switching option 5, 6. In a second method step 103, the electric tool 1 is locked with respect to a modification of the at least one adjusted device setting by actuating the first switching function 7. The locked state of the electric tool 1 can be signaled in a third method step 104, for example, by the first switching function 7 or a separate lamp of the electric tool 1 lighting up.

If one of the switching options 5, 6 of the user interface 2 is actuated in a fourth method step 105, the device settings of the electric tool 1 remain unchanged. In order to indicate to a user that the electric tool 1 is locked, this can be signaled, for example, in a fifth method step 106 by causing the first switching function 7 or the separate lamp of the electric tool 1 to flash when one of the switching options 5, 6 is actuated in the locked state of the electric tool 1. The electric tool 1 can be connected to the terminal device 3. However, all second switching options of user interface 11 are grayed out in this case and cannot be activated. However, the second switching function 12 is not grayed out and can be actuated to unlock the electric tool 1.

In a sixth method step 107, the electric tool 1 can be unlocked by actuating the first switching function 7 of the user interface 2 or by actuating the second switching function 12 on the terminal device 3. In a seventh method step 108, unlocking can be signaled, for example, by the first switching function 7 first flashing and then going out.

If, in an eighth method step 109, the electric tool 1 is disconnected from the power supply source 4 for less than a predeterminable period of time, the electric tool 1 remains locked in a ninth method step 110. If, in a tenth method step 111, the electric tool 1 is disconnected from the power supply source 4 for longer than a predeterminable period of time, the electric tool 1 is reset to the factory settings in an eleventh method step 112. The predeterminable period of time can be five minutes, for example, but it can also be chosen differently. After the ninth method step 110, the first method 100 can be repeated starting at the first method step 101. After the twelfth method step 112, the first method 100 may be repeated starting from the initial situation.

FIG. 3 schematically shows a flow diagram of a second method 100 for operating an electric tool 1 according to FIG. 1.

In a first method step 201, the electric tool 1 is connected to the terminal device 3. The electric tool 1 is exemplary in the factory setting with regard to its operating modes A, B and with regard to the operating parameter. For example, no operating mode A, B is selected. Speed level 3′ is also set as an operating parameter by way of example. In a second method step 202, at least one device setting is adjusted by actuating a second switching option of the user interface 11. In a third method step 203, a menu change takes place in order to be able to access the second switching functions 12, 13, 14. In a fourth method step 204, the electric tool 1 is locked with respect to a modification of the at least one adjusted device setting by actuating the second switching function 12. In a fifth method step 205, the locked state of the electric tool 1 can be signaled on the user interface 11. Submenus of the user interface 11 appear grayed out when the electric tool 1 is locked. In an optional sixth method step 206, at least one device setting is readjusted by actuating a first switching option 5, 6 of the user interface 2 of the electric tool 1. The user interface 2 is therefore not locked and can still be operated. In a seventh method step 207, the electric tool 1 can be unlocked by actuating the second switching function 12 of the user interface 11 of the terminal device 3. Following the seventh method step 207, the second method step 202 and the subsequent method steps 203, 204, 205, 206, 207 can be repeated.

When operating the electric tool 1, it is possible for the at least one device setting to be adjusted via the user interface 2 and the electric tool 1 to be locked via the terminal device 3, or for the at least one device setting to be adjusted via the terminal device 3 and the electric tool 1 to be locked via the user interface 2. If at least one further device setting is adjusted, wherein the at least one further device setting comprises at least one further operating mode and/or at least one further operating parameter of the electric tool 1, the device setting can be adjusted via the user interface 2 and the further device setting can be adjusted via the terminal device 3. The electric tool 1 can also be unlocked via the user interface 2 or the terminal device 3 by activating a corresponding switching function 7, 12.

In an optional eighth method step 208, the electric tool 1 is connected to a further terminal device. The further terminal device has a further user interface with third switching options for adjusting the at least one device setting and a third switching function for locking the electric tool 1. In a ninth method step 209, it can be queried whether the at least one adjusted device setting should be retained. The at least one adjusted device setting can be retained in a tenth method step 210 or modified in an eleventh method step 211 via the further terminal device. If the at least one adjusted device setting is retained in the tenth method step 210, the fifth method step 205, the subsequent sixth method step 206 and the subsequent seventh method step 207 can be repeated. If the at least one adjusted device setting is modified in the eleventh method step 211, the second method step 202 and the subsequent method steps 202, 203, 204, 205, 206, 207 may be repeated.

FIG. 4 schematically shows a flow diagram of a third method 300 for operating an electric tool 1 according to FIG. 1.

In a first method step 301, the electric tool 1 is connected to the terminal device 3. By way of example, the electric tool 1 is in the factory setting with regard to its operating modes A, B and with regard to the operating parameter. In a second method step 302, at least one device setting is adjusted by actuating a second switching option of the user interface 11. In a third method step 303, a menu change takes place in order to be able to access the second switching functions 12, 13, 14. In a fourth method step 304, the electric tool 1 is locked with respect to a modification of the at least one adjusted device setting by actuating the second switching function 12.

In a fifth method step 305, a password required for unlocking the electric tool 1 is activated by actuating the additional second switching function 14 of the user interface 11. In a sixth method step 306, the password is entered on the terminal device 3 and stored in the terminal device 3. In a seventh method step 307, the locked state of the electric tool 1 can be signaled on the user interface 11. Submenus of the user interface 11 appear grayed out when the electric tool 1 is locked. In an optional eighth method step 308, at least one device setting is readjusted by actuating a first switching option 5, 6 of the user interface 2 of the electric tool 1. The user interface 2 is therefore not locked and can still be operated.

In a ninth method step 309, the electric tool 1 can be unlocked by actuating the second switching function 12 of the user interface 11 of the terminal device 3. In a tenth method step 310, the password is queried and the password is entered into the terminal device 3. If the password entered is correct, this is confirmed in an eleventh method step 311. In a twelfth method step 312, the electric tool 1 is then unlocked. The third method 300 can then be repeated starting with the second method step 302. If the password entered is incorrect, this is determined in a thirteenth method step 313. In a fourteenth method step 314, a message is sent that the password was incorrect. The password can then be entered again or the process can be canceled. If no correct password is entered, the lock of the electric tool 1 is maintained in a fifteenth method step 215. In this case, the third method 300 can be repeated starting at the seventh method step 307.

Starting from the state of the electric tool 1 after the eighth method step 308, i.e. in the locked state, the electric tool 1 can be connected to a further terminal device in an optional sixteenth method step 316. The further terminal device has a further user interface with the third switching options for adjusting the at least one device setting and the third switching function for locking the electric tool 1. In a seventeenth method step 317, it can be queried whether the at least one adjusted device setting should be retained. If this is the case, the password is queried in an eighteenth method step 318 and entered into the other terminal device. If the password entered is correct, this is confirmed in a nineteenth method step 319. In a twentieth method step 320, it can be queried whether the at least one adjusted device setting should be retained. If it is to be modified, the unlocking is repeated in the twelfth method step 312. If it is not to be modified, it is retained in a twenty-first method step 321. If the password is incorrect, this is determined in a twenty-second method step 322. In a twenty-third method step 323, a message is sent that the password was incorrect. The password can then be entered again or the process can be canceled. If no correct password is entered, the lock of the electric tool 1 is retained in the twenty-first method step 321. In this case, the third method 300 can be repeated starting at the seventh method step 307.

FIG. 5 schematically shows a flow diagram of a fourth method 400 for operating an electric tool 1 according to FIG. 1.

In a first method step 401, the electric tool 1 is connected to the terminal device 3. By way of example, the electric tool 1 is in the factory setting with regard to its operating modes A, B and with regard to the operating parameter. In a second method step 402, at least one device setting is adjusted by actuating a second switching option of the user interface 11. In a third method step 403, device settings can be additionally adjusted by actuating a first switching option 5, 6 of the user interface 2. In a fourth method step 404, a menu change takes place in order to be able to access the second switching functions 12, 13, 14.

In a fifth method step 405, the user interface 2 is disabled by actuating the further second switching function 13. The blocking of the user interface 2 can be signaled in a sixth method step 406, for example, by the first switching function 7 of the user interface 2 lighting up. If one of the switching options 5, 6 of the user interface 2 is actuated in a seventh method step 407, the device settings of the electric tool 1 remain unchanged. In order to indicate to a user that the electric tool 1 is locked, this can be signaled, for example, in an eighth method step 408 by causing the first switching function 7 of the electric tool 1 to flash when one of the switching options 5, 6 is actuated in the locked state of the electric tool 1.

In a ninth method step 409, the electric tool 1 can be unlocked by actuating the first switching function 7 of the user interface 2 or by actuating the further second switching function 13 on the terminal device 3. In a tenth method step 410, unlocking can be signaled, for example, by the first switching function 7 first flashing and then going out.

If, in an eleventh method step 411, the electric tool 1 is disconnected from the power supply source 4 for less than a predeterminable period of time, the electric tool 1 remains locked in a twelfth method step 412. If, in a thirteenth method step 413, the electric tool 1 is disconnected from the power supply source 4 for longer than a predeterminable period of time, the electric tool 1 is reset to factory settings in a fourteenth method step 414. The predeterminable period of time can be five minutes, for example, but it can also be chosen differently. After the twelfth method step 412, the fourth method 400 may be repeated beginning at the sixth method step 406. After the fourteenth method step 414, the fourth method 400 may be repeated starting with the first method step 401.

1. A method for operating an electric tool, comprising:
adjusting at least one device setting of the electric tool by actuating at least one tool-internal switching option or a tool-external switching option, wherein the at least one device setting comprises at least one operating mode and/or at least one operating parameter of the electric tool; and
locking the electric tool with respect to a modification of the at least one adjusted device setting by actuating a tool-internal or tool-external switching function, wherein the electric tool is locked until one of the switching functions is actuated.

2. The method according to claim 1, wherein:
the electric tool comprises a user interface having first switching options for adjusting the at least one device setting and a first switching function for locking the electric tool,
wherein the at least one device setting is adjusted via the user interface by actuating the first switching option and/or the electric tool is locked via the user interface by actuating the first switching function.

3. The method according to claim 1, further comprising:
connecting the electric tool to a terminal device,
wherein the terminal device has a user interface with a second switching option for adjusting the at least one device setting and a second switching function for locking the electric tool, and
wherein the adjustment of the at least one device setting and/or the locking of the electric tool is carried out via the terminal device by actuating the second switching option or the second switching function.

4. The method according to claim 2, wherein (i) the at least one device setting is adjusted via the user interface and the electric tool is locked via the terminal device, or (ii) the at least one device setting is adjusted via the terminal device and the electric tool is locked via the user interface.

5. The method according to claim 3, wherein locking the electric tool via the terminal device comprises locking the at least one device setting by actuating the second switching function or locking the user interface by actuating a further second switching function.

6. The method according to claim 1, further comprising:
adjusting at least one other device setting, the at least one further device setting comprising at least one further operating mode and/or at least one further operating parameter of the electric tool,
wherein the device setting is adjusted via the user interface and the at least one other device setting is adjusted via the terminal device.

7. The method according to claim 1, further comprising:
connecting the electric tool to a further terminal device, which has a further user interface with third switching options for adjusting the at least one device setting and a third switching function for locking the electric tool,
wherein at least one adjusted device setting is retained or modified via the other terminal device.

8. The method according to claim 3, further comprising:
activating a password required for unlocking the electric tool via the terminal device by activating an additional second switching function of the user interface of the terminal device.

9. The method according to claim 1, wherein the electric tool remains locked when the electric tool is separated from a power supply source for less than a predeterminable period of time.

10. The method according to claim 1, wherein the electric tool is reset to factory settings if the electric tool is disconnected from a power supply source for longer than a predeterminable period of time.

11. An electric tool comprising:
a user interface;
a terminal device; and
a control device, configured to be connected to the user interface and to the terminal device, the control device being configured to:
adjust at least one device setting of the electric tool is adjusted via a switching option of the user interface or a switching option of the terminal device, the at least one device setting comprising at least one operating mode and/or at least one operating parameter of the electric tool; and
lock the electric tool with regard to a modification of the at least one adjusted device setting via a switching function of the user interface or the terminal device until one of the switching functions is actuated.

12. A control device for an electric tool configured to execute the method according to claim 1,
wherein the control device is designed to be connectable to a user interface of an electric tool and to a terminal device, and
wherein the control device is designed to receive signals transmitted to the control device from the user interface or from the terminal device with commands relating to at least one device setting and to execute the commands.
